(19) United States
(12) Patent Application Publication
(10) Pub. No.: US 2026/0025832 A1
(43) Pub. Date: Jan. 22, 2026

(54) DYNAMIC CARRIER AGGREGATION RECONFIGURATION

(71) Applicant: T-Mobile USA, Inc., Bellevue, WA (US)

(72) Inventors: Jasinder Pal Singh, Olathe, KS (US); Nishant Patel, Irvine, CA (US)

(21) Appl. No.: 18/778,829

(22) Filed: Jul. 19, 2024

(51) Int. Cl. H04W 72/232; H04L 5/00

(52) U.S. Cl. CPC H04W 72/232; H04L 5/001

(57) ABSTRACT

The present invention relates to a method and system for wireless communication. The method includes the transmission of a radio resource control (RRC) message from a base station to user equipment. The RRC message contains information regarding a set of available component carriers. A Downlink Control Information (DCI) signal is transmitted from the base station to the user equipment, scheduling a transmission. The DCI signal includes a carrier aggregation (CA) reconfiguration field that indicates the reconfiguration of one or more component carriers from the set to be aggregated for the transmission. The base station then receives the transmission from the user equipment, which is performed by aggregating the specified component carriers.

### BACKGROUND

Telecommunications involves the transmission of information over distances using electronic systems, such as telephones, radios, televisions, and the internet. It enables voice, data, and video communication, connecting people and businesses worldwide. The industry has evolved to include modern fiber-optic networks and wireless technologies. One of the latest advancements in telecommunications is 5G, the fifth generation of mobile network technology. 5G offers faster data speeds, lower latency, and greater capacity compared to its predecessors, enabling new applications like autonomous vehicles, smart cities, and advanced Internet of Things (IoT) devices. It operates on a broader range of frequency bands, including millimeter waves, which provide high-speed connections but require more infrastructure due to their shorter range. One solution to these shorter ranges is carrier aggregation (CA), which combines multiple frequency bands to enhance data speeds. The deployment of 5G is expected to revolutionize various industries by providing more reliable and efficient communication solutions.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a flowchart that illustrates components of RRC reconfiguration.

FIG. 3 is a block diagram that illustrates components of DCI signaling.

FIG. 4 is a flowchart that illustrates a method for dynamic signaling.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Carrier aggregation (CA) is a technique used in wireless communication to increase the data rate and capacity of a network. For example, in downlink transmissions from the base station to user equipment, downlink carrier aggregation can be configured to support up to six component carriers, where a component carrier is essentially a band of spectrum, or a carrier, that can be aggregated with other carriers to provide wider bandwidths and thus higher data rates. Each component carrier has a certain bandwidth (for example, 20 MHZ), and by combining multiple component carriers, a network can provide significantly higher data rates.

With the increasing demand of data uploads from users, it is also desirable to provide carrier aggregation features for uplink transmissions from the user equipment to the base station. Uplink component combinations can change, however, during the duration of a call as the combinations are determined based on coverage and/or capacity of the carriers. Currently, when the uplink component carriers change, a Radio Resource Configuration (RRC) signaling (e.g., RRC reconfiguration) is used to reconfigure the component carriers. Statically configuring all available component carriers for uplink transmissions is not desirable because the uplink power can be unnecessarily divided due to such configuration, leading to reduced coverage and also signaling delay.

This patent document discloses techniques that can be implemented in various embodiments to enable dynamic reconfiguration of uplink CA to achieve optimal power distribution and coverage with reduced signaling overhead. In some embodiments, dynamic signaling messages, such as Downlink Control Information (DCI) signaling, can be used to reconfigure the uplink component carriers to avoid the signaling overhead that comes with the RRC reconfiguration procedure. The dynamic configuration also avoids the possible coverage issues caused by the static allocation of uplink power. In some embodiments, the disclosed techniques enable dynamic reconfiguration of downlink CA in addition to—or instead of—uplink CA.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

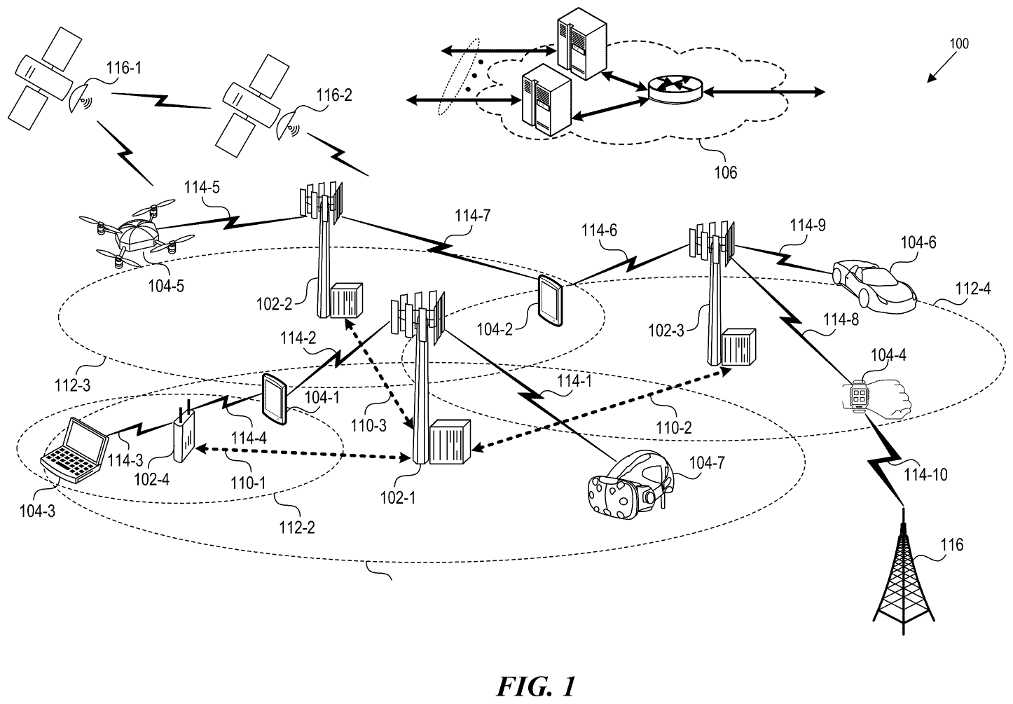

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the radio resource control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple subcarriers (e.g., waveform signals of different frequencies) modulated according to the various radio technologies. Each modulated signal can be sent on a different subcarrier and carry control information (e.g., reference signals, control channels), overhead information, user data, etc. The communication links 114 can transmit bidirectional communications using frequency-division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Dynamic Carrier Aggregation Reconfiguration

Current and future generations of wireless communication technology (e.g., 4G, 5G, or 6G) enable UEs to operate at higher frequency bands to achieve faster data rates. However, these higher frequencies have a shorter range, which means that, in order to remain connected to the network, a user can experience a greater number of “handovers” as they transfer from one high-frequency cell to another. Increasing the number of handovers increases the likelihood that a UE experiences a dropped call, a lower quality of service, or higher latency.

One solution to this problem is carrier aggregation (CA). CA is a technique used in wireless communication to increase the data rate and capacity of a network by combining multiple component carriers (CCs). Combining more CCs provides wider bandwidths and higher data rates and expands the range a UE can travel without the need for a handover, as the UE is already connected to one or more Secondary Cells (SCells) in addition to a Primary Cell (PCell).

However, transmitting signals over multiple carriers simultaneously requires more power. This is less of an issue in downlink (DL) transmission from the base station (e.g., gNodeB or eNodeB) to the UE because the base station can use a power grid or large batteries to access higher power levels. In the case of UL transmissions from the UE to the base station, however, the power demands for CA are more limiting, as the UE often only has access to batteries with limited capacity (e.g., in the case of mobile phones). Therefore, it is not desirable to configure all available carriers for a UE because doing so can lead to reduced power and correspondingly reduced coverage areas.

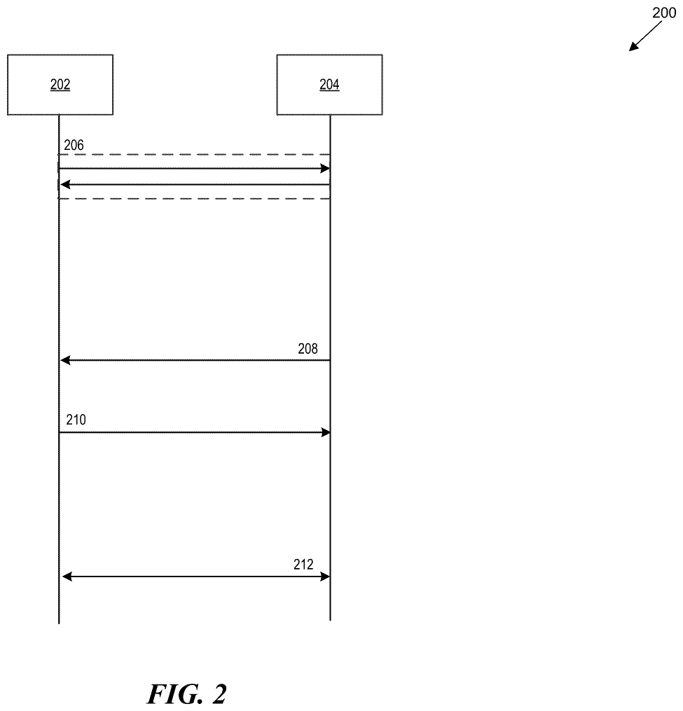

One method that a network can use to set up or modify the UE for CA is radio resource control (RRC). RRC is a protocol used in mobile communication networks, including LTE (Long-Term Evolution) and 5G NR (New Radio), to manage the radio resources between the User Equipment (UE) and the base station (eNodeB in LTE or gNodeB in 5G). The RRC protocol is responsible for the establishment, maintenance, and release of RRC connections, as well as for the configuration of various parameters related to the radio interface. FIG. 2 is a flowchart that illustrates components of a reconfiguration 200. In some implementations, the reconfiguration 200 is an RRC reconfiguration. The reconfiguration 200 can also be an initial configuration.

The reconfiguration 200 begins with an initial attach phase 206. The initial attach phase 206 allows a UE 202 to establish a connection with a network 204 when the UE 202 first powers on or enters a new cell. The initial attach phase 206 can include several steps for the UE 202 to connect to the network 204. In some implementations, the UE 202 scans frequency bands to find and select a cell with the best signal quality. Next, the UE 202 reads system information from the selected cell. The UE 202 then initiates the random access procedure by sending a preamble to the base station, which responds with timing and resource information. The UE 202 establishes an RRC connection with the base station through a series of request and setup messages. The UE 202 performs a Non-Access Stratum (NAS) attach procedure to register with the core network, involving steps like sending an attach request, undergoing authentication, and receiving an attach accept message. Finally, the network sets up a default bearer for initial data communication, involving session requests and responses between the Mobility Management Entity (MME) or the Access and Mobility Management Function (AMF) and the Serving Gateway (SGW) or User Plane Function (UPF).

After this, the network 204 can send the UE 202 an RRC Reconfiguration message 208. The RRC Reconfiguration message 208 can be used to set up or modify the reconfiguration 200. The main functions of the RRC Reconfiguration message 208 include configuring radio bearers, measurements, and SCells or cell groups on the UE 202. For each component, it can establish, modify, or release configurations. For example, it can set up a new radio bearer, modify measurement parameters, or release a secondary cell group.

Following the RRC Reconfiguration message 208, an acknowledgment message 210 (e.g., RRC Reconfiguration Complete) is sent from the UE 202 to the network 204. The acknowledgment message 210 indicates the reconfiguration process has been finalized by the UE 202.

Subsequent to the acknowledgment message 210, there is an established connection 212 between the UE 202 and the network 204. As a result of the previous steps in the reconfiguration 200, the established connection 212 can include a new data channel, adjusted signal measurement settings, or modified secondary cells for improved data throughput.

Reconfiguration 200 can occur frequently in dynamic network environments to enable a UE 202 to adapt to changing conditions like user mobility and traffic loads, which increases signaling traffic and latency. For example, in a busy urban area with high user mobility, such as people commuting on public transportation, a UE 202 frequently moves between different cell towers, and the network 204 constantly sends RRC Reconfiguration messages to adapt to the changing locations, varying traffic loads, and/or potential interference from numerous devices. Additionally, the complex procedures, large message sizes, retransmissions, processing time, and coordination with other network tasks further contribute to delays and bandwidth consumption.

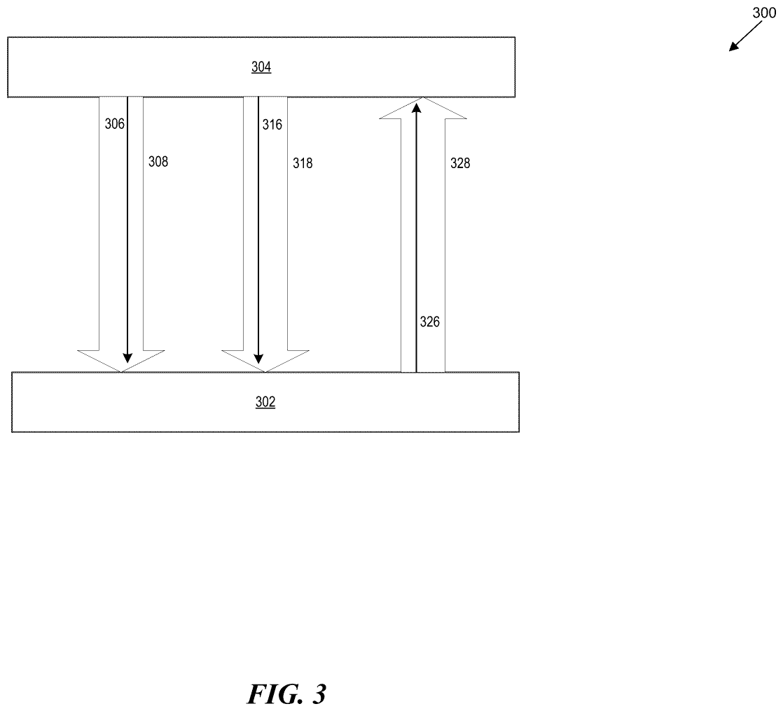

The disclosed technology can solve the above problems, and others, by enabling dynamic CA reconfiguration using DCI signaling. FIG. 3 is a block diagram that illustrates components of DCI signaling 300. DCI signaling 300 is different from reconfiguration 200 in that DCI focuses on the immediate control of data transmission, while RRC handles broader tasks like setting up the connection, managing mobility, and configuring security parameters.

The DCI signaling 300 includes a dynamic signal 306 transmitted from a network 304 (e.g., the base station) to a UE 302 (e.g., a mobile device or a device) on a Physical Downlink Control Channel (PDCCH) 308. The dynamic signal 306 can carry information to schedule a downlink transmission 316 on a Physical Downlink Shared Channel (PDSCH) 318 and an uplink transmission 326 on a Physical Uplink Shared Channel (PUSCH) 328.

Configurations via the DCI signaling on the PDCCH are faster than the RRC signaling because DCI signaling operates at the physical layer, which handles immediate control tasks, and is transmitted more frequently. The PDCCH carries simpler, lower-latency information needed for quick resource allocation and efficient network performance.

For example, the information carried by the dynamic signal 306 can include allocating resources and specifying modulation schemes. In some implementations, the signaling 306 includes instructions on configuring the UE 302 to assign frequency blocks to use for downloading data and how to decode it. The signaling 306 can lead to more efficient network 304 performance and ensure that the UE 302 receives and processes the downlink transmission 316 correctly or that the network 304 receives and processes the uplink transmission 326 correctly.

In order for the dynamic signal 306 to be decodable on both the network 304 and the UE 302, it follows previously defined and agreed-upon formats and protocols. Such formats can include those decided as part of the 3rd Generation Partnership Project (3GPP) or the 5G New Radio (NR) standards. In some implementations, these formats include details concerning DCI signaling 300, such as the encoding and decoding processes, the structure of the physical channels, and how data is multiplexed and transmitted over the air interface. Such formats can be tailored for scheduling uplink transmissions on the PUSCH 328 (e.g., DCI formats 0_0, 0_1, or 0_2), or they can be tailored for scheduling downlink transmissions on PDSCH 318 (e.g., DCI formats 1_0, 1_1, or 1_2), or they can be for other purposes, such as scheduling of sidelink or scheduling of MBS (Multicast Broadcast Services). Such formats can include previously defined formats that have been altered or redefined to include a field that indicates a reconfiguration of one or more component carriers used for a transmission. Such a reconfiguration can include a power control command from the network 304 to the UE 302, configuring the UE 302 to redirect power from a first set of component carriers to a second set of component carriers, wherein the first and second sets of component carriers are associated with different cell areas. Several example DCI formats are discussed below.

DCI format 0_0 can be used for scheduling of PUSCH in one cell. It can include information such as resource allocation, modulation and coding scheme, and power control commands. For example, DCI format 0_0 is typically used for uplink grant in a single cell scenario.

DCI format 0_1 can be used for scheduling of PUSCH in one or multiple cells. Signals structured according to format 0_1 are similar to DCI format 0_0 but include additional fields to support multi-cell scheduling. For example, format 0_1 is suitable for scenarios where uplink resources need to be allocated across multiple cells.

DCI format 0_2 can be used for scheduling of PUSCH with additional features such as beamforming. Signals structured according to format 0_2 can contain fields for resource allocation, modulation and coding scheme, power control, and beamforming information. For example, format 0_2 is designed for advanced uplink scheduling scenarios that require beamforming capabilities.

Carrier aggregation introduces additional complexity in the way DCI signals communicate resource allocation. The DCI must now handle multiple component carriers, manage cross-carrier scheduling, and provide detailed resource block allocations. In 5G NR, more advanced resource allocation types are used, which can handle the increased complexity of CA more efficiently. In some embodiments, a new field that is different from the existing carrier indicator field in format 0_1 is included within the DCI signaling 306 to help the UE 302 identify which component carrier(s) are used for uplink CA. The bit width of this new field in the DCI varies according to the number of component carriers available in the network and/or according to UE capabilities. In LTE, the new field can be 3 bits or 4 bits long, indicating up to 8 or 16 component carriers, respectively (e.g., number of bits=log ₂ (number of component carriers)). In 5G NR, the new field can be 3 bits, 4 bits, or even longer, depending on the number of component carriers, providing the flexibility to indicate a larger number of component carriers as needed.

In some implementations, take DCI format 0_0 as an example, a new field can be defined as follows as the indication, in addition to the existing fields specified in Technical Specification (TS) 38.212:
—Carriers for Aggregation—number of bits determined by the following:

$$⌈ {log}_{2} ( a maximum number of available CCs ) ⌉$$

For example, when a maximum number of two CCs are available for uplink transmissions, only one bit is needed to indicate whether a single CC is used or two CCs are aggregated. Alternatively, the number of bits can be determined by the following:

$$⌈ ceil ( {log}_{2} ( a total number of available CCs ) ) ⌉$$

For example, the number of bits returned by a logarithmic function can be fractional, and a ceiling function can round this number up to the nearest whole bit.

In some embodiments, take DCI format 0_0 as another example, a new field can be defined as:
—Carriers for Aggregation—number of bits determined by the total number of available CCs.

For example, when a total number of four CCs are available for uplink transmissions, each bit corresponds to a CC to indicate which CC(s) are aggregated.

The new field can be present when the UE supports more than one CC for uplink transmissions.

In some implementations, existing padding bits (e.g., DCI format 0_0) can be used to indicate the CC(s) for uplink CA. The number of bits of the indication is based on the total count of available CCs for the uplink CA.

In some embodiments, take DCI format 0_1 as another example, a new field can be defined as:
—Carriers for Aggregation—number of bits determined by the following:

$$⌈ {log}_{2} ( a total count of available CCs ) ⌉$$

In some implementations, the number of bits can be calculated using an entropy function. For example, the entropy function indicates an amount of uncertainty—or the number of bits required—in the new field with regard to which component carriers (of the maximum number of component carriers) will be indicated for aggregation for the scheduled transmission. The number of bits for the field can be determined by the following:

$$H ( X ) = - {\sum }_{i = 1}^{N} P ( {x}_{i} ) {log}_{2} P ( {x}_{i} )$$

For example, H(X) is the bit width for the new field, represented by the random variable (X). P(x_i) is the probability of the i-th component carrier being indicated for aggregation. Some component carriers can be indicated for aggregation more frequently than others in DCI signals; space can be allocated accordingly so as not to waste unnecessary bits indicating the aggregation of highly improbable component carriers. The logarithm to the base (2) is used in order to calculate the number of bits (e.g., alternative bases include (e) for nats or (10) for dits or bans). The summation is over all possible component carriers (N).

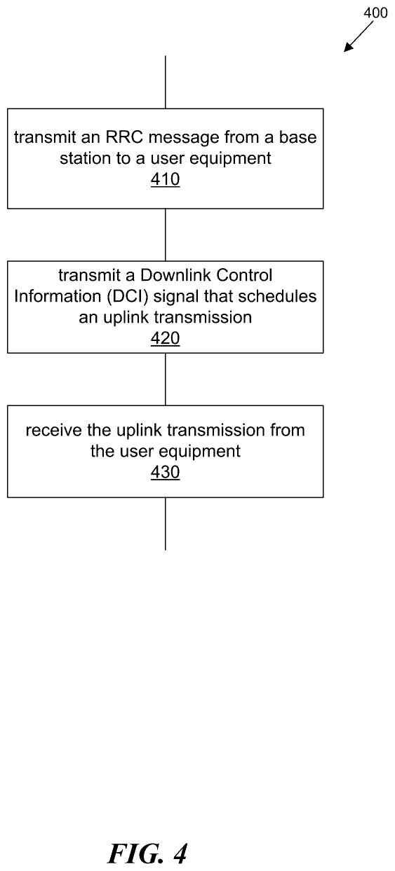

FIG. 4 is a flowchart that illustrates a method 400 for dynamic signaling in accordance with one or more embodiments of the present technology. The method 400 includes, at operation 410, transmitting a radio resource control (RRC) message from a base station to a user equipment. In some implementations, the RRC message includes information about a set of available component carriers. The information can include bandwidths, timing schedules, and resource blocks (RBs) for each component carrier comprised by the set of available component carriers. Any subset of the component carriers comprised by the set of available component carriers can be used for carrier aggregation (CA).

The method 400 includes, at operation 420, transmitting, from the base station to the user equipment, a Downlink Control Information (DCI) signal that schedules an uplink transmission. The DCI signal can be a signaling that schedules a downlink transmission 416. In some implementations, the DCI signal comprises a carrier aggregation (CA) reconfiguration field. In some implementations, the field can have other names. The CA reconfiguration field can indicate a reconfiguration of one or more component carriers to be aggregated for the uplink transmission. In some implementations, the one or more component carriers are comprised by the set of available component carriers.

In some implementations, the CA reconfiguration field has a bit width in the DCI signal that is associated with the available component carriers and/or the one or more component carriers to be aggregated. The bit width of the CA reconfiguration field can be calculated according to a variable N. For example, N can be determined from a cardinality of the set of available component carriers or from a total number of component carriers of the one or more component carriers. The bit width of the CA reconfiguration field can equal N, log ₂ (N), or ceil (log ₂ (N)). In some implementations, the DCI signal includes existing padding bits, and the CA reconfiguration field can be included within these existing padding bits (e.g., in DCI format 0_0).

In some implementations, the one or more component carriers include one or more resource blocks (RBs). The DCI signal 418 can include an RB assignment field with a bit width in the DCI signal 418. The RB assignment field can be based on a total number of the one or more component carriers, as well as a total number of the one or more RBs.

In some implementations, the CA reconfiguration field is associated with uplink power control of the user equipment. The user equipment can redirect power from a first set of component carriers to a second set of component carriers. For example, the first set of component carriers and the second set of component carriers can both be included within the set of available component carriers transmitted to the user equipment from the base station via the RRC message. In some implementations, the reconfiguration of the one or more component carriers is triggered by a change in network resources. The network can be a telecommunications network that includes the base station. Network resources can include quality of service (QOS), available bandwidth, time slots, and other RBs. For example, a base station can experience an increase in traffic while a user equipment is connected to the base station. In such an occurrence, the base station can indicate to the user equipment a reconfiguration from a set of four component carriers to a set of two component carriers via the CA reconfiguration field in the DCI signal. In this way, the user equipment can reduce the bandwidth of its connection, thereby reducing the number of component carriers it needs to power and also reducing the total amount of power required to transmit its scheduled uplink transmission.

The method 400 can include, at operation 430, receiving, by the base station, the uplink transmission from the user equipment. In some implementations, the uplink transmission is performed by aggregating the one or more component carriers. In other implementations, the method 400 includes receiving the downlink transmission from the base station at the user equipment.

In some embodiments, the bit width of the new field (or the use of existing padding bits) depends on a bandwidth configuration and a number of resource blocks (RBs) configured for the corresponding transmission (e.g., PUSCH). RBs are used to allocate resources (e.g., time and bandwidth) for data transmission to users. RBs represent a specific amount of time-frequency resources that can be assigned to a UE 302 for data transmission. In the frequency domain, an RB can include a fixed number of subcarriers. For example, in LTE, an RB typically consists of 12 subcarriers, each with a subcarrier spacing of 15 kHz, making the total bandwidth of an RB 180 KHz. In 5G NR, the subcarrier spacing can vary (e.g., 15 kHz, 30 kHz, 60 kHz, etc.), but the number of subcarriers per RB remains 12. In the time domain, an RB can span a certain number of Orthogonal Frequency-Division Multiplexing (OFDM) symbols. For example, in LTE, an RB spans one slot, which consists of 7 OFDM symbols in normal cyclic prefix mode or 6 OFDM symbols in extended cyclic prefix mode. In 5G NR, the number of OFDM symbols per slot can vary depending on the numerology (subcarrier spacing) used. The network 304 can assign RBs to the UE 302 based on channel conditions, including quality of service (QOS) requirements, and traffic demand. RBs can also carry DCI and Uplink Control Information (UCI).

Based on the indication information, a bit width for the RB assignment field can be kept manageable, as it only needs to address the resource blocks within a single component carrier at a time. The bit width for the RB assignment field can dynamically adapt based on the number of aggregated component carriers and their respective resource blocks. This ensures efficient use of the available bits in the DCI message.

The indication in the DCI signaling can be used to dynamically indicate the change of uplink carriers for CA based on the coverage and bandwidth capacities. In some embodiments, the UE can dynamically determine uplink power upon selected component carriers being activated by the DCI signaling. Doing so enables optimal power usages for uplink transmissions and avoids static uplink power configuration that can lead to reduced coverage for the UEs.

### Computer System

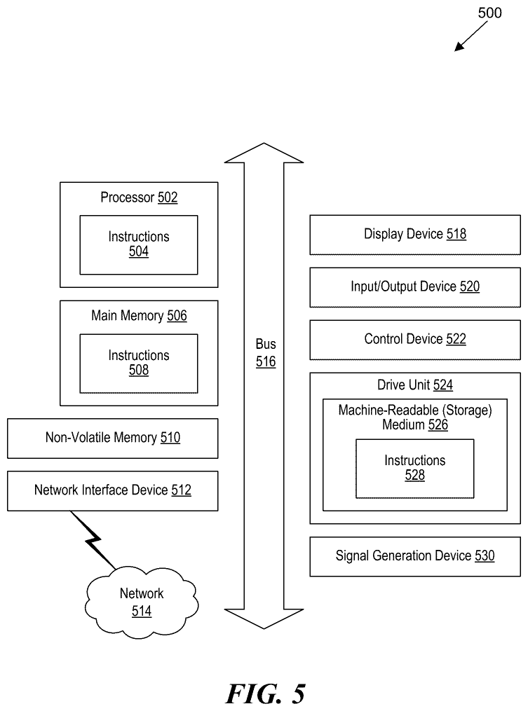

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A method for wireless communication, comprising:
transmitting a radio resource control (RRC) message from a base station to a user equipment,
wherein the RRC message includes information about a set of available component carriers;
transmitting, from the base station to the user equipment, a Downlink Control Information (DCI) signal that schedules an uplink transmission,
wherein the DCI signal comprises a carrier aggregation (CA) reconfiguration field that indicates a reconfiguration of one or more component carriers of the set of available component carriers to be aggregated for the uplink transmission; and
receiving, by the base station, the uplink transmission from the user equipment,
wherein the uplink transmission is performed by aggregating the one or more component carriers.

2. The method of claim 1, wherein the CA reconfiguration field has a bit width in the DCI signal, wherein the set of available component carriers has a cardinality N, and wherein the bit width of the CA reconfiguration field is equal to:
N,
log ₂ (N), or
ceil (log ₂ (N)).

3. The method of claim 1, wherein the CA reconfiguration field has a bit width in the DCI signal, wherein the one or more component carriers are associated with a number that represents a total count of component carriers to be aggregated N, and wherein the bit width of the CA reconfiguration field is equal to:
N,
log ₂ (N), or
ceil (log ₂ (N)).

4. The method of claim 1, wherein the CA reconfiguration field has a bit width in the DCI signal, wherein the set of available component carriers has a cardinality N, wherein P(xi) is a probability of an i-th component carrier of the set indicated for aggregation, and wherein the bit width of the CA reconfiguration field is equal to:
$${\sum }_{i = 1}^{N} P ( {x}_{i} ) {log}_{2} P ( {x}_{i} ) .$$

5. The method of claim 1, wherein the DCI signal includes existing padding bits, and wherein the existing padding bits comprise the CA reconfiguration field.

6. The method of claim 1, wherein the one or more component carriers include one or more resource blocks (RBs), wherein the DCI signal includes an RB assignment field, and wherein a bit width of the RB assignment field is based on a total number of the one or more component carriers and the one or more RBs.

7. The method of claim 1, wherein the reconfiguration includes a power control command that configures the user equipment to redirect power from a first set of component carriers to a second set of component carriers, wherein the first set of component carriers and the second set of component carriers are comprised by the one or more component carriers to be aggregated.

8. The method of claim 6, wherein the reconfiguration is triggered by a change in network resources.

9. A system, comprising:
at least one hardware processor; and
at least one non-transitory memory storing instructions, which, when executed by the at least one hardware processor, cause the system to:
transmit a configuration message from a node to a mobile device,
wherein the configuration message includes information about component carriers; and
transmit, from the node to the mobile device, a Downlink Control Information (DCI) signal,
wherein the DCI signal comprises a field that indicates a reconfiguration of the component carriers to be aggregated for a transmission.

10. The system of claim 9, wherein the field has a bit width in the DCI signal, and wherein the information about the component carriers includes a maximum number of component carriers N, and wherein the bit width of the field is equal to:
N,
log ₂ (N), or
ceil (log ₂ (N)).

11. The system of claim 9, wherein the field has a bit width in the DCI signal, wherein the component carriers to be aggregated are associated with a number that represents a total count of the component carriers to be aggregated N, and wherein the bit width of the field is equal to:
N,
log ₂ (N), or
ceil (log ₂ (N)).

12. The system of claim 9, wherein the DCI signal includes existing padding bits, and wherein the existing padding bits comprise the field.

13. The system of claim 9, wherein the component carriers include resource blocks (RBs), wherein the DCI signal includes an RB assignment field, and wherein a bit width of the RB assignment field is based on a total number of the component carriers and the RBs.

14. The system of claim 9, wherein the reconfiguration includes a power control command that configures the mobile device to redirect power from a first set of component carriers to a second set of component carriers, wherein the first set of component carriers and the second set of component carriers are comprised by the component carriers to be aggregated.

15. A non-transitory, computer-readable storage medium comprising instructions recorded thereon, wherein the instructions, when executed by at least one data processor of a system, cause the system to:
transmit a first message to a device that includes information about component carriers; and
transmit to the device a dynamic signal that causes a reconfiguration of the component carriers for aggregation for a transmission.

16. The non-transitory, computer-readable storage medium of claim 15, wherein the dynamic signal includes a field with a bit width in the dynamic signal, and wherein the information about the component carriers includes a maximum number of component carriers N, and wherein the bit width of the field is equal to:
N,
log ₂ (N), or
ceil (log ₂ (N)).

17. The non-transitory, computer-readable storage medium of claim 15, wherein the dynamic signal includes a field with a bit width in the dynamic signal, wherein the component carriers for aggregation are associated with a number that represents a total count of the component carriers for aggregation N, and wherein the bit width of the field is equal to:
N,
log ₂ (N), or
ceil (log ₂ (N)).

18. The non-transitory, computer-readable storage medium of claim 15, wherein the dynamic signal includes existing padding bits, and wherein the existing padding bits comprise a field that indicates a reconfiguration of the component carriers to be aggregated for the transmission.

19. The non-transitory, computer-readable storage medium of claim 15, wherein the component carriers for aggregation include one or more resource blocks (RBs), wherein the dynamic signal includes an RB assignment field, and wherein a bit width of the RB assignment field is based on a total number of the component carriers for aggregation and the one or more RBs.

20. The non-transitory, computer-readable storage medium of claim 15, wherein the reconfiguration includes a power control command that configures the device to redirect power from a first set of component carriers to a second set of component carriers, wherein the first set of component carriers and the second set of component carriers are included in the component carriers for aggregation.
